(19) United States
(12) Patent Application Publication
(10) Pub. No.: US 2007/0154607 A1
(43) Pub. Date: Jul. 5, 2007

(54) Dough and method for preparing leavened food product

(76) Inventors: Jorge A. Ulate-Rodriguez, Brooklyn Park, MN (US); Liza B. Levin, Plymouth, MN (US)

Correspondence Address: GENERAL MILLS, INC., P.O. BOX 1113, MINNEAPOLIS, MN, 55440, US

(21) Appl. No.: 10/577,571

(22) PCT Filed: Nov. 3, 2003
(86) PCT No.: PCT/US03/35227

§ 371 Date: Jan. 30, 2007

(51) Int. Cl. A23D 9/013

(52) U.S. Cl. 426/531

(57) ABSTRACT

A dough composition is disclosed comprising native starch, pre-gelatinized starch, egg, milk, bulking agent, and fat, wherein the dough contains less flour than starch as provided by the native and pregelatinized starches combined, and water serves as the primary leavening agent. A method of preparing a dough for a leavened product is also disclosed. The method involves combining native starch, pre-gelatinized starch, water, fat, egg and less than 3% by weight gluten at a temperature lower than the gelatinization temperature of the native starch.

### BACKGROUND OF THE INVENTION

Pao de queijo is a food staple of the Brazilian diet. Although widely unknown outside of Brazil, it is perhaps best described as a sort of leavened cheese bread. However, the term “bread” is a misnomer as traditional pao de queijo contains no flour and in particular contains no gluten. Traditional Brazilian pao de queijo in part derives its distinctive flavor from the ingredient of fermented cassava starch that is otherwise known as sour starch. Other ingredients included in traditional pao de queijo include sweet or unfermented starch, egg, milk or water, salt, cheese, and fat. The terms pao de queijo and Brazilian cheese bread are used interchangeably herein.

As mentioned above, sour starch has to date been a necessary ingredient in pao de queijo. Sour starch is a product of Brazil and Colombia and is a product of the natural fermentation of cassava starch. The fermentation process necessary to manufacture sour starch normally takes between thirty to forty days and can take as long as sixty days depending upon the weather conditions. The process curiously requires solar radiation to dry. The manufacture of sour starch using other heat sources has been attempted with less than optimum results. Sour or fermented starch is notable for its functional properties when used in baked goods. Most importantly, sour starch allows for dough expansion during baking providing texture for leavened baked goods.

A traditional pao de queijo has a flavor and texture somewhat similar to cream puffs or popovers. It is likely that the flavor of pao de queijo is somewhat reminiscent of popovers probably due to the high egg content of both products. Although pao de queijo is a starch-based rather than flour or gluten based leavened food product, it is not a crisp snack food product. Many well-known starch based food products are crisp snack foods such as potato chips, tortilla chips, or corn chips. Pao de queijo differs quite dramatically from these types of foods even though they both have high starch content and may all lack gluten. In contrast to snack foods, pao de queijo has relatively high moisture content once it is baked. The texture is more similar to bread than to a crisp snack food.

Attempts have been made to eliminate the sour starch in traditional pao de queijo with limited success. Sour starch imparts both distinctive texture and flavor to the pao de queijo so much that eliminating the ingredient to date has resulted in a marginally acceptable product. Manufacture of traditional pao de queijo also requires heating the sweet and sour starches, milk, and fat to a temperature to ensure gelatinization of the starches. The combination is then cooled before adding the egg to ensure that the egg proteins are not denatured before baking. Ground cheese and salt are added along with or after the egg. The required heating and cooling takes both time and energy especially when scaled up for manufacturing large batches of dough.

Desirably a traditional tasting pao de queijo could be made without requiring the heating and, therefore, the cooling steps necessary when using a traditional pao de queijo recipe. Additionally, it would be desirable if sour starch could be excluded from the ingredients. If so, one would no longer be tied to using a product that is only manufactured artisanally in Brazil and Colombia. Both of these changes would ideally result in a product that is easier and cheaper to manufacture yet would have the texture and taste of a traditional pao de queijo. To date, it has been impossible to manufacture a high quality pao de quiejo and eliminate the sour starch whether manufacturing above or below the starch gelatinization temperature.

### SUMMARY OF THE INVENTION

A composition and method of making a leavened Brazilian cheese bread is provided. It has surprisingly been found that a traditional pao de queijo can be closely approximated without the once necessary component of fermented cassava starch. The new composition does not require the use of fermented cassava starch. Rather, the composition includes pre-gelatinized starch in combination with a native starch. The composition additionally requires egg, fat, water, and a bulking agent. Cheese may optionally be added. If cheese is not added, additional fat, milk proteins, and cheese flavorings may be added to approximate the flavor and mouth feel of cheese in the leavened product in order to provide a close approximation of traditional pao de queijo.

A method of manufacturing dough for a leavened Brazilian cheese bread product is also provided. The method is accomplished at a temperature below the gelatinization temperature of the native starch. The importance of operating in this temperature range is that the dough can be manufactured at an ambient temperature and thus, any requirement to heat the starch before baking is eliminated thereby reducing manufacturing time and costs. Surprisingly, the quality of traditional pao de quiejo is closely approximated using the method of the present invention even though the method is conducted below the gelatinization temperature of the starch.

The process of the invention includes combining pre-gelatinized starch, native starch, and a bulking agent. The starch and bulking agent combination is blended with fat. Water, egg, and fat in addition to that present in the egg are blended with the starch mixture until a dough is formed. Cheese is optionally added to the combination. The dough is then either deposited into about tablespoon size portions and baked or optionally the dough is frozen. The freezing is accomplished either by freezing the entire amount of dough, freezing individually deposited serving size portions, or breaking the dough into serving size portions to freeze for baking at a later time.

### DETAILED DESCRIPTION

It is an aspect of the present invention that the composition of the invention includes both a native starch and a pre-gelatinized starch. By use of the term “native” starch it is meant that the starch has not been modified either by chemical, enzymatic, physical, or heat degradation. As used herein, the term starch does not refer to the flour from which it was derived. Rather, the term “starch” only refers to the isolated carbohydrate portion of the flour after the gluten or protein portions have been removed. Native starch is preferably present in the dough composition of the invention in amounts from about 10 to about 40 percent by weight, and more preferably from about 12 to about 35 percent by weight, and most preferably from about 15 to about 25 percent by weight. Preferably the source of the native starch is cassava, however, other sources are useful for providing the native starch to the composition of the invention. Suitable alternative starch sources are discussed below.

The term “pre-gelatinized” starch as used herein refers to a starch that is gelatinized prior to adding to the other ingredients of the dough composition. Native starch is gelatinized by heating the starch granules in the presence of water. The granules are then able to absorb water and swell, thereby putting greater and greater stress on the crystalline regions. Within a certain range of temperatures, the characteristic of each starch molecule suddenly loses all organized structure and becomes an amorphous network of starch and water intermingled. This is called the gelatinization range or the gelatinization temperature, because the granules become tiny gels, or liquid-containing meshworks of long molecules. This range is between about 140-148 degrees F. (60-64.4 degrees C.) for wheat flour, and between about 144 and 158 degrees F. (62.2-70.0 degrees C.) for cornstarch. Both flour and cornstarch are produced from seeds. Other sources of starch exist which include rice starch and root starches such as arrowroot, tapioca or cassava, and potato to name a few. These starches tend to gelatinize at lower temperatures than the seed starches. In the case of commercially available pre-gelatinized starch, this amorphous network is then dried and the pre-gelatinized starch is added as a dry ingredient. As anyone knows, native starch and cold water are not miscible until heated. However, once heated within the gelatinization temperature range, the mixture thickens. Alternatively, if a pre-gelatinized starch is added to cold water the mixture will thicken without requiring heating.

Pre-gelatinized starch is preferably present in the composition of the invention in amounts of from about 0.5 percent to about 20 percent by weight, more preferably from about 2 to about 15 percent by weight, and most preferably from about 4 to about 10 percent by weight. Suitable sources of starches for either the native starch or the pre-gelatinized starch include corn, wheat, rye, rice, oat, cassava, barley, potato, sago, pea, sorghum, amaranth, or mixtures thereof.

Although it is not necessary or even desirable to include flour in the present invention, if flour is added to the dough of the present invention, it is in an amount so as not to interfere with the bubble formation and bubble set necessary to prepare the leavened food product closely approximating pao de quiejo. The texture and crumb of the leavened baked food product of the invention is not derived from gluten or other flour proteins. Additionally, if flour is included in the composition, the starch content of the flour is in addition to the native starch and pre-gelatinized starch of the invention. Different types of flour contain varying amounts of gluten or protein. For the purposes of this invention it is important that the amount of gluten in the composition is minimized. It is also important to balance the amounts of pre-gelatinized starch and native starch, along with the amount of bulking agent and water. For the purposes of this invention, we assume that flour contains from about 7 percent by weight up to about 14 percent by weight protein or gluten. If flour is included in the invention, the amount of native starch added to the composition should ideally be reduced to compensate for the starch added in the flour. If flour is optionally added to the composition of the present invention it is in an amount of up to about 20 percent by weight so as not to interfere with the taste, structure, and mouth feel of the baked product. Desirably, the composition will contain less than about 3% by weight gluten, more preferably less than 2% by weight, most preferably 0% gluten by weight. As stated earlier, it is most preferable to include no flour or negligible flour in the composition so as to minimize the gluten in the composition.

Refined gluten may optionally be added to the composition of the present invention. As explained above, it is preferable that gluten is not included in the composition of the invention. This is true if the gluten is added in the form of flour or if it is added as purified gluten. If gluten is added to the composition of the invention it should be in an amount so as not to create a matrix and so as not to interfere with the formation of the protein-starch matrix typically found in traditional Brazilian cheese bread.

A bulking agent is added to the composition of the invention. Without being bound by theory it is believed that the bulking agent serves to bind water to a limited degree, contributing to a slightly increased viscosity of the composition of the dough of the invention, but still allowing water release or steam release during baking. It is hypothesized that the dough composition of the present invention is effective at producing Brazilian cheese bread because it allows for a controlled release of water or more particularly, steam during baking, that leavens the food product. To this end, the choice of bulking agent is somewhat important since it is preferably a largely inert ingredient that likely does not otherwise react with the ingredients of the composition other than water. Further, a preferable bulking agent does not change upon heating or when the dough having a composition of the invention is heated. If such a bulking agent is chosen it should not affect the final baked texture of the baked product of the invention.

Suitable bulking agents include but are not limited to carbohydrates such as dextrin or maltodextrin; collagen; insoluble fibers such as cellulose, methyl cellulose, carboxymethyl cellulose, hydroxypropyl methyl cellulose, and microcrystalline cellulose. A single bulking agent may be used or more than one bulking agent may be combined in the composition of the invention. By use of the term “bulking agent” herein, it may refer to a single ingredient or to any number of ingredients that together comprise the bulking agent in a particular formulation of the composition of the present invention.

Bulking agents are chosen so that they minimally interact with other ingredients in the formula. For the present invention, the bulking agent is likely added to control the viscosity of the dough or flow properties. The best bulking agent is preferably an inert material that is added to increase the volume of the composition. A preferred bulking agent useful in the present invention is maltodextrin. One skilled in the art will recognize that if a starch derivative or sugar is used as the bulking agent or as a portion of the bulking agent, it may affect browning or flavor of the baked good. Therefore, it is desirable to consider all of these factors when selecting the appropriate type or combination of bulking agents as well as the amount of bulking agent used.

The amount of bulking agent necessary to create a dough having a desirable consistency will be somewhat dependent upon the bulking agent chosen. The amount of the bulking agent(s) used is/are chosen to provide a dough having a suitable consistency. That is, certain bulking agents require a very small amount to be added before a desirable consistency of dough is obtained while other bulking agents may require a larger amount to obtain a similar consistency. Preferably, the dough does not spread drastically upon baking. Rather, it preferably holds its shape, that being more of a somewhat spherical dinner roll shape than a flat cookie shape.

One method of testing whether or not appropriate amounts of the ingredients are included, such as an appropriate amount of bulking agent is included thus creating a dough is of a suitable consistency, is the following: Balls of dough weighing 25 grams are formed and frozen. The frozen dough balls are baked for 25 minutes at 375 degrees F. After allowing the baked dough to cool for 5 minutes, the height and diameter of the balls are measured. The height is averaged and the diameter is averaged. Next each baked dough ball is weighed and the volume of the baked goods is measured by the commonly known rapeseed displacement method. The height to diameter ratio is calculated and baked goods having had dough with acceptable ingredients have a height to diameter ratio in the range of about 1.0 to 1.5. Finally, the specific volume is calculated by dividing the volume by the weight. Acceptable specific volumes are those greater than about 2.0. Upon baking and cooling, the product should have an outward appearance that is generally symmetrical, lacks deep cracks or fissures, and lacks indentations on the top due to collapsing. Additionally, upon examining a cross section of the baked good, the interior should lack large holes. A large hole is one that comprises greater than about 25% of the cross section.

Preferably the composition of the invention includes a bulking agent in the range of from about 1 to about 20 percent by weight. More preferably the composition of the invention includes a bulking agent in the range of from about 2 to about 14 percent by weight. Most preferably the composition of the invention includes a bulking agent in the range of from about 4 to about 9 percent by weight.

Water is a component of the invention. Water added to the composition is in addition to moisture that is present in egg of the invention. If flour or cheese is included in the composition of the invention, the moisture present in these optional ingredients is in addition to the water content of the composition. Water may optionally be added in the form of milk. Including milk in place of water or as a portion of the water will provide a slightly higher protein content in the composition of the invention as the milk provides additional protein in the form of casein. In addition, milk provides a different flavor than water but this is an acceptable or even preferred variation in the invention.

Water is an ingredient of the invention and is used to both hydrate the ingredients and to create steam during baking which in turn serves to leaven the product when the steam is released. Since the product of the invention is primarily steam leavened this explains why the choice of bulking agent is important so as not to interfere with the release of the water via steam. Water is added to the dough as liquid water, ice, or it is added via hydrated ingredients. Ice may be added to supply water to dough in order to keep the combination cool during mixing. Water is preferably present in the dough in the range from about 15 to 40 percent by weight, more preferably from about 18 to 35 percent by weight, and most preferably from about 20 to about 30 percent by weight.

While water is a necessary component of the invention, it is hypothesized that it is not merely the amount of water added that creates a successful product. Rather, it is believed that it is the management of the water or the controlled release of the water that creates a desirable Brazilian cheese bread product. This water management is accomplished by the overall composition of the dough. That is, the water is useful in gelatinizing or partially gelatinizing the native starch during baking and it is useful in creating steam.

No other leavening agent other than water or steam is necessary in the present invention, although yeast or yeast flavoring or chemical leavening agents may optionally be added to the composition. Although yeast or yeast flavoring or any other type of chemical leavener could be added to the composition of the invention it is not preferable because these would likely impart flavors distinct from a traditional pao de queijo product and might interfere with the texture of the baked product. For purposes of the present invention, a chemical leavening system is a combination of chemical ingredients that react to produce carbon dioxide. Preferably, these chemical ingredients are a combination of an acid and a base that react to release carbon dioxide into the dough and thereby increase the volume of the dough. Suitable leavening acids are generally known in the industry and include but are not limited to citric acid, sodium acid pyrophosphate (SAPP), sodium aluminum phosphate (SALP), monocalcium phosphate (MCP), dicalcium phosphate (DCP), sodium aluminum sulfate (SAS), anhydrous monocalcium phosphate (AMCP), dimagnesium phosphate (DMP), dicalcium phosphate dihydrate (DCPD), gluconodelta lactone (GDL) and mixtures thereof. Suitable bases used in leavening agents generally include a carbonate and/or a bicarbonate salt. Suitable carbonate and bicarbonate salts include, for example, sodium carbonate, potassium carbonate, sodium bicarbonate (commonly known as baking soda), potassium bicarbonate, ammonium bicarbonate and mixtures thereof. An example of a chemical leavening system that could be included in the present invention but, as stated earlier, is not desirable to include in the present invention, is the combination of sodium bicarbonate and a combination of SAPP and SALP leavening acids. If yeast or a chemical leavening system is included in the composition less than about 1.5 percent by weight is included, more preferably less than about 1.0 percent by weight, and most preferably less than about 0.5 percent by weight is included.

Egg is another component of the invention. Whether or not fresh eggs are added directly cracked from shells is unimportant for the present invention. If fresh eggs are not used, egg components such as fat, protein, lecithin, and water may alternatively be added to approximate egg in the final composition. Liquid egg is preferably present in the composition of the invention in the range from about 5 to 25 percent by weight, more preferably from about 8 to about 22 percent by weight, and most preferably from about 12 to about 18 percent by weight. Without being bound by theory it is believed that some of the egg protein together with the starch of the composition serve to create the baked matrix necessary to create a leavened pao de queijo product. It is hypothesized that if milk is added to the composition of the invention the milk protein may also serve in part to form the baked matrix in the baked product of the invention.

Fat is another component of the composition of the present invention. Fat is in addition to the fat present in the other ingredients. In particular, fat is in addition to that present in the egg or flour if it is included. As stated previously, if water is added to the dough instead of milk, milk proteins and fat are added to approximate milk. If fat is added along with water and milk proteins such as casein to approximate milk, this fat is in addition to the fat component otherwise present in the composition of the invention. Possible fat ingredients include, for example, oils and solid fats. Suitable oils include, for example, soybean oil, corn oil, canola oil, olive oil, sunflower oil, peanut oil, and other vegetable or nut oils. Suitable solid fats include, for example, animal fats such as butter and hydrogenated vegetable oils such as margarine. Without being bound by theory it is believed that fat serves a couple of purposes in creating a successful leavened baked product of the invention. First, it provides additional flexibility or stretch to the starch based dough that otherwise wouldn't be present to allow the dough portion to expand during baking. Generally, more fatty doughs result in weaker matrix structure producing softer dough products. Second, it provides a desirable mouth feel. Third, it provides flavor to create a more authentic tasting Brazilian cheese bread product and the fat can act as a flavoring agent providing a richer tasting dough. Fats also have a tenderizing effect on bread-like products due to the fact that the lipids act to slow loss of moisture by coating the starch granules.

Preferably the composition of the invention includes added fat in the range of from about 1 to about 15 percent by weight, more preferably in the range of from about 2 to about 11 percent by weight, and most preferably in the range of from about 3 to about 8 percent by weight.

Cheese is surprisingly an optional ingredient in the composition of the invention. Even though the product is roughly translated as Brazilian cheese bread and the traditional product includes cheese, a suitable product may be manufactured that includes cheese substitutes. Preferably, real cheese is included in the composition of the invention in the range of amount up to about 30 percent by weight. More preferably real cheese is added to the composition of the invention in the range up to about 26 percent by weight, and most preferably up to about 22 percent by weight.

While a traditional pao de quiejo includes ground Minas and Parmesan cheese, any type of cheese may optionally be added to the composition of the invention. Optionally the cheese may be grated, however, this may result in cheese particles that are discernible which is acceptable but is not traditionally found in Brazilian cheese bread. When ground cheese is added to the pao de queijo dough the flavor permeates the dough without creating perceivable chunks of cheese in the baked product. Further, traditionally hard cheese is ground and added to the dough in this manner. Suitable hard cheeses include but are not limited to Romano, Manchego, Grana Padano, and Asiago. Semi-hard cheese, semi-soft, soft cheese, liquid cheese, or a cheese paste may be added to the dough of the present invention. A single cheese or a combination of several cheeses may be added to the composition of the present invention.

As explained earlier if cheese is added to the composition of the invention, the fat present in the cheese is in addition to the fat otherwise present in the composition. Likewise, if fat, milk proteins, and flavorings are added to closely approximate cheese, these ingredients are in addition to the fat and other ingredients otherwise present in the composition of the invention. While it is most desirable to include cheese in the present invention, a manufacturer may choose to include cheese-substituting ingredients in order to reduce cost, improve processing, or to alter the flavor of the final baked product.

Salt is another optional ingredient of the invention. Although salt is not necessary from a product leavening or performance standpoint, it is desirable from a flavor or taste standpoint. Salt is preferably added in the range up to about 2 percent by weight, more preferably in the range up to about 1.5 percent by weight, and most preferably in the range up to about 1 percent by weight.

The dough composition of the invention may optionally include flavoring agents. Such flavoring agents include but are not limited to such ingredients as salt, cocoa, whey, malt, yeast or yeast extract, inactivated yeast, spices, herbs, vanilla, and commercially available flavorants, such as butter flavor. The optional flavoring agent preferably is present as up to about 5 percent by weight, more preferably up to about 3 percent by weight, and most preferably up to about 1 percent by weight.

Besides flavoring agents, the dough can further include preservatives and emulsifiers. Suitable emulsifiers include, for example, mono- and di-glycerides of fatty acids, propylene glycol mono- and di-esters of fatty acids, glycerol-lacto esters of fatty acids, ethoxylated mono-glycerides, lecithin, protein, and mixtures thereof. Preferred emulsifiers include mono-glycerides and mixtures of propylene glycol mono- and di-esters of fatty acids, mono-glycerides and lecithin. Preservatives and emulsifiers combined comprise preferably less than about 5 percent by weight of the dough, and each preferably between about 0.1 percent and about 2.5 percent by weight of the dough. Suitable preservatives provide shelf-life extension for the baked product, and include, for example, potassium sorbate, sorbic acid, sodium propionate, and sodium diacetate.

Method of Manufacturing

The composition of the starches and bulking agent(s) is preferably balanced within the dough to provide appropriate hydration, water bonding, and water release properties favorable to dough expansion, bubble development, and bubble set found in traditional Brazilian cheese bread. The method of practicing the present invention surprisingly no longer requires the heating of the starches yet the quality of traditional pao de quiejo is closely approximated. The composition of the invention can be prepared at any temperature below the gelatinization temperature of the particular native starch used in the composition. More importantly, the composition of the invention can be prepared completely at ambient temperature. Ambient temperature, as used herein refers to temperature in the range of 50° F. up to about 100° F., more preferably 60° F. to 90° F., and most preferably 62° F. to 82° F. Manufacturing at ambient temperature is desirable as less energy is required to manufacture the Brazilian cheese bread having the composition of the invention. Less energy is required since it is not necessary to first gelatinize the native starch while mixing and; therefore, it is unnecessary to cool the composition before adding the egg in order to avoid premature denaturazition of the egg proteins.

The dry ingredients are combined. These include native starch and pregelatinized starch. The dry ingredients are blended with a fat, preferably margarine, for up to about 4 minutes, more preferably up to about 3 minutes, and most preferably for up to about 2 minutes. A second addition of ingredients is added to the dry ingredient-fat blend. Water or milk and eggs, fat and salt are added to the dry ingredient-fat blend and the combination is blended for about 3 to 8 minutes, more preferably about 4 to 7 minutes and most preferably about 4 to 6 minutes. In the second ingredient addition the fat is preferably oil such as canola, soy, palm, coconut, bean, vegetable, corn, or olive oil. After the second blending is complete ground cheese or cheeses are optionally added. The final composition including the cheese(s) is blended until homogenous. The ingredients are blended in a Hobart mixer as is commercially available. Once this final mixing is complete, the dough is ready for processing.

The dough is then separated into individual balls or deposited into pucks for baking into individual size breads ranging from about 5 to about 100 grams. Optionally the dough is shaped into loaves that are either individual portion size or multi-portion size. The dough pieces are then either immediately baked for imminent consumption or frozen for later baking. The frozen dough pieces may be packaged to sell with the consumer ultimately baking the product. The dough is baked either in a frozen or thawed state. The fact that the dough may be baked frozen thereby makes the dough a freezer to oven dough. Baking is accomplished by placing the dough pieces onto a baking sheet and placing the baking sheet into a conventional or convection oven and baking until the individual pieces are puffed and golden. The baking time and temperature will vary depending upon the size of the individual dough pieces.

### EXAMPLES

### Comparative Example

This Comparative Example contains the traditional ingredient of fermented starch derived from cassava root normally found in Brazilian pao de queijo. The composition of this Comparative Example also lacks the bulking agent and pregelatinized starch of the invention.

| Ingredient | Percentage by weight |
|---|---|
| Fermented Cassava Starch | 16.25 |
| Native Cassava Starch | 16.25 |
| Liquid Milk | 20 |
| Liquid Eggs | 12.5 |
| Ground Farmers Cheese | 21.2 |
| Fat* | 13.1 |
| Salt | 0.7 |

*A combination of soybean oil and margarine was used.

The ingredients were all placed in a dough mixer and combined until a homogenous mass formed. Individual serving size balls were formed and frozen. The frozen balls were baked in a 375 degree F conventional oven until they were puffed and light golden brown in color. The baked dough was removed from the oven and allowed to cool. The resulting cooled baked product was puffed, had a desirable texture, desirable mouth feel and taste.

### Examples 1-3

For these examples no fermented starch was added to any of the combinations. For Examples 1 and 3, maltodextrin served as the bulking agent. For Example 2, tapioca dextrin served as the bulking agent. Example 3 varied the amount of pre-gelatinized starch and bulking agent in the composition as compared to Examples 1 and 2.

| | Example 1 | Example 2 | Example 3 |
|---|---|---|---|
| | Percentage by | Percentage by | Percentage by |
| Ingredient | weight | weight | weight |
| Native Cassava Starch | 24 | 24 | 20 |
| Maltodextrin | 7 | 0 | 10 |
| Tapioca dextrin | 0 | 7 | 0 |
| Pre-gelatinized starch | 7 | 7 | 10 |
| Liquid Eggs | 14 | 14 | 16 |
| Milk | 24 | 24 | 24 |
| Ground Cheese | 16 | 16 | 10 |
| Vegetable Fat | 8 | 8 | 10 |

The ingredients for each example were placed in separate dough mixers and combined until homogenous masses formed. Individual serving size balls of about 5 to 100 g were formed and frozen. The frozen balls were baked in a 375 degree F. conventional oven until they were puffed and light golden brown in color.

The baked products of Examples 1-3 were cooled. The cooled baked products remained puffed, had a desirable texture, desirable mouth feel and taste for a pao de queijo.

The embodiments described herein are illustrative in nature, and are not intended to limit the scope of the invention. One skilled in the art will recognize that variations are possible without departing from the spirit or scope of the invention.

1. A dough for preparing a leavened food product comprising native starch, pre-gelatinized starch, egg, water, bulking agent, and fat wherein the leavened structure is not created from gluten and wherein the bulking agent is present in the range of about 2-14% by weight.

2. The dough of claim 1 further comprising cheese.

3. The dough of claim 1 wherein the native starch is comprised of cassava starch.

4. The dough of claim 1 Wherein the pre-gelatinized starch is comprised of cassava starch.

5. The dough of claim 1 wherein the moisture content is greater than 20 percent by weight.

6. The dough of claim 1 wherein the water in the dough serves as the leavening agent.

7. The dough of claim 1 wherein the bulking agent is comprised of maltodextrin.

8. The dough of claim 1 wherein the bulking agent is comprised of dextrin.

9. The dough of claim 1 wherein the dough is substantially gluten free.

10. The dough of claim 1 wherein the dough is substantially free of fermented starch.

11. A method of preparing a baked leavened food product comprising baking the dough of claim 1.

12. The baked leavened food product of claim 11 wherein the moisture content of the baked product is greater than 15% by weight.

13. The dough of claim 1 wherein the dough is frozen.

14. A method of preparing a baked leavened food product comprising baking the frozen dough of claim 13.

15. A dough composition comprising native starch, pre-gelatinized starch, egg, milk, bulking agent, and fat, wherein the dough contains less flour than starch as provided by the native and pregelatinized starches combined, and water serves as the sole leavening agent.

16. The dough composition of claim 15 wherein the composition is substantially gluten free.

17. The dough composition of claim 15 wherein the composition is substantially lacking fermented starch.

18. A baked leavened food product comprising a native starch, pre-gelatinized starch, egg, water, bulking agent, and fat wherein the leavened texture is not created from gluten and the product has a moisture content of greater than 20 percent by weight and the product is substantially fee of chemical leaveners.

19. The baked leavened food product of claim 18 wherein the product is substantially gluten free.

20. The baked food product of claim 18 wherein the moisture content is greater than about 15 percent by weight.

21. The baked food product of claim 18 wherein water is the leavener.

22. The baked food product of claim 18 further comprising cheese.

23. The dough composition of claim 15 wherein the composition contains less than 3 percent by weight gluten.

24. A dough composition for preparing a leavened food product comprising native starch, pre-gelatinized starch, egg, water, bulking agent, and fat wherein the dough contains negligible flour and the bulking agent is present in the range of about 2-14% by weight.

25. A method of preparing a dough for a leavened product comprising combining native starch, pre-gelatinized starch, water, fat, egg, bulking agent and less than 3% by weight gluten at a temperature lower than the gelatinization temperature of the native starch wherein the dough is substantially free of chemical leaveners.

26. The method of claim 25 wherein milk is added instead of water.

27. The method of claim 25 wherein margarine and oil comprises the fat.

28. The method of claim 25 further comprising including cheese in the combination.

29. A dough composition comprising:
native starch in the range of about 10-40% by weight,
pre-gelatinized starch in the range of about 0.5-20% by weight,
eggs in the range of about 5-25% by weight,
water in the range of about 15-40% by weight,
bulking agent in the range of about 2-14% by weight,
gluten in the range of 0-3% by weight, and
flat in the range of about 1-15% by weight wherein water serves as the leavening agent.

30. The dough composition of claim 25 further comprising cheese in the amount of up to about 30% by weight.
